(19) United States
(12) Patent Application Publication
(10) Pub. No.: US 2009/0324890 A1
(43) Pub. Date: Dec. 31, 2009

(54) OPTICAL FILM

(75) Inventors: Ting-Yuang WU, Kaohsiung (TW); Yi-Chung Shih, Kaohsiung (TW)

Correspondence Address: LADAS & PARRY LLP, 26 WEST 61ST STREET, NEW YORK, NY, 10023, US

(73) Assignee: ETERNAL CHEMICAL CO., LTD.

(21) Appl. No.: 12/490,609

(22) Filed: Jun. 24, 2009

(30) Foreign Application Priority Data
Jun. 25, 2008 (TW) 097123844

(51) Int. Cl. B32B 3/30

(52) U.S. Cl. 428/167

(57) ABSTRACT

The present invention pertains to an optical film comprising a substrate and a microstructured layer on a surface of the substrate, wherein the microstructured layer comprises a plurality of columnar structures and the columnar structures comprise at least two members selected from the group consisting of a linear columnar structure with its height varying along the length direction, a linear columnar structure without its height varying along the length direction, a serpentine columnar structure with its height varying along the length direction, and a serpentine columnar structure without its height varying along the length direction.

The optical film of the present invention enhances the brightness and efficiently reduces optical interference.

### BACKGROUND OF THE INVENTION

1. Field of the Invention

The present invention relates to an optical film, in particular, a brightness enhancing film applicable to liquid crystal displays (LCDs).

2. Description of the Prior Art

It is known that liquid crystal display (LCD) panels cannot emit light, and thus, backlight modules serving as brightness source become important for liquid crystal displays (LCDs) and are crucial for enhancing the brightness of the displays. Currently, various optical films are used in backlight modules to enhance the brightness of LCD panels and to maximize the efficiency of the light sources without altering any elemental design or consuming additional energy. Such an approach has become the most economical and convenient solution.

FIG. 1 is a schematic illustration of the various optical films in a backlight module. As shown in FIG. 1, a typical backlight module comprises a reflective film (1) below a lightguide (2) and other films including a diffusion film (3), brightness enhancing films (4) and (5) and a protective diffusion film (6), which are arranged, from the bottom to the top, above the lightguide (2).

The major role of a diffusion film is to provide a uniform area light source. A brightness enhancing film, also known as brightness enhancement film or prism film, is to collect the scattered light rays by refraction and internal total reflection, and to converge the rays in the on-axis direction of about ±35 degrees to enhance the luminance of the LCDs. A typical brightness enhancing film gathers light rays by means of the linear prisms arranged regularly on the film.

A conventional brightness enhancing film (as shown in FIG. 2 and disclosed in, for example, WO 96/23649 and U.S. Pat. No. 5,262,800), comprises a substrate (21) and a plurality of prisms (22) parallel to each other on the substrate (21), where each prism has two slant surfaces and said two slant surfaces meet at the top of the prism to form a peak (23). The two slant surfaces each meet a slant surface of the adjacent prism at the bottom of the prism to form a valley (24). Due to the fixed width and regular arrangement of the strip-shaped structures of the brightness enhancing film disclosed in the prior art, optical interference caused by the light rays refracted or reflected by other films of the displays or by the brightness enhancing film itself could be generated, thereby resulting in moiré or mura in appearance.

FIG. 3 is a schematic diagram of the brightness enhancing film disclosed in U.S. Pat. No. 6,354,709. There is a plurality of microstructured prisms (8) on a substrate (7). The linear prisms are parallel to each other and the height of each prism varies along the length direction. However, although modifications have made on the film disclosed in this prior art reference, that is, the heights of the prisms or the distances between the prisms are altered, the light-enhancing structures are still with regularity, i.e., peaks and valleys of the prisms are still in parallel and are all linearly and regularly arranged. Such structures cannot reduce mura phenomena.

U.S. Pat. No. 5,919,551 discloses an optical film with columnar structures where each columnar structure has two or more peaks of different heights. Such linear prism structures include at least two peaks in one single prism structure. Since it is difficult to simultaneously emboss two peaks, the production yield is low and the cost is high.

It is known that a protective diffusion film, or called upper diffusion film, can be configured on the brightness enhancing film to reduce optical interference and prevent the brightness enhancing film from the damage caused by abrasion with other films due to vibration in transportation. However, this approach increases the cost and complexity of the backlight module structure.

### SUMMARY OF THE INVENTION

The present invention provides an optical film which can reduce optical interference and eliminate the above disadvantages.

The optical film of the present invention comprises a substrate and a microstructured layer on a surface of the substrate, wherein the microstructured layer comprises a plurality of columnar structures and the columnar structures are composed of at least two members selected from the group consisting of a linear columnar structure with its height varying along the length direction, a linear columnar structure without its height varying along the length direction, a serpentine columnar structure with its height varying along the length direction and a serpentine columnar structure without its height varying along the length direction.

### BRIEF DESCRIPTION OF THE DRAWINGS

FIG. 1 is a schematic illustration of various optical films in a backlight module.

FIG. 2 is a schematic illustration of a conventional brightness enhancing film.

FIG. 3 is a schematic illustration of a brightness enhancing film of the prior art.

FIGS. 4 to 13 are schematic diagrams of the embodiments of the optical film according to the present invention.

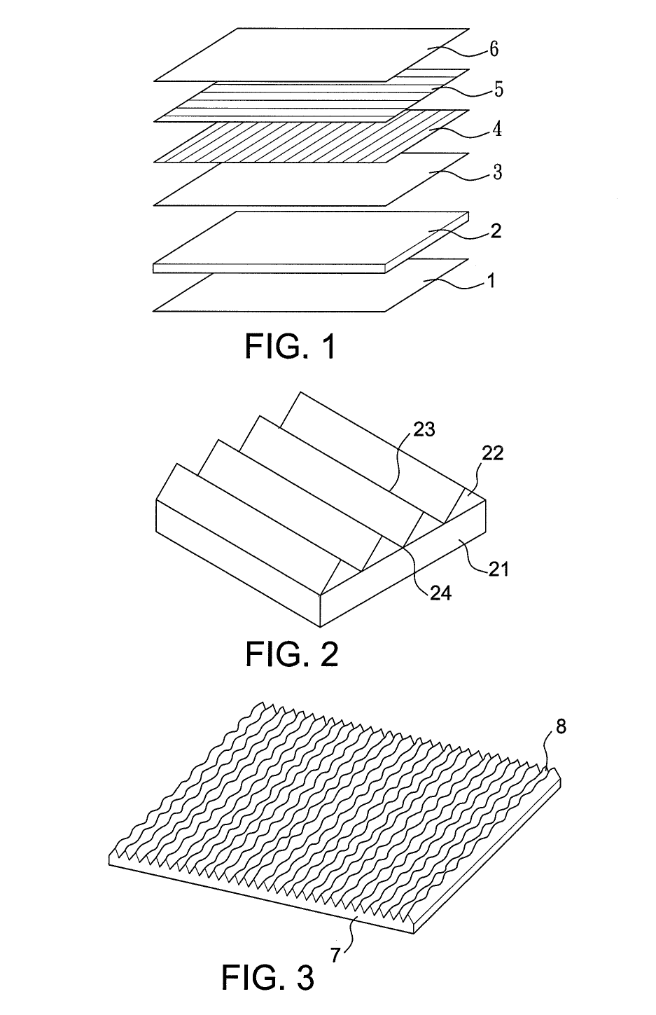

### DETAILED DESCRIPTION OF THE INVENTION

The term “multi-peaked columnar structure” used herein represents a combined structure composed of at least two columnar structures overlapping each other, and the valley line between any two adjacent columnar structures has a height of 30% to 95% of the height of the lower one of the adjacent columnar structures.

The term “single-peaked prismatic columnar structure” used herein represents a structure composed of a single prismatic columnar structure with one single peak.

The term “valley line” used herein represents the line which is formed by the adjacent side surfaces of two adjacent columnar structures.

The term “height of a columnar structure” used herein represents the perpendicular distance from the peak to the bottom of a columnar structure.

The term “height of a valley line” used herein represents the perpendicular distance from a valley line to the bottom of the adjacent columnar structures.

The term “width of a columnar structure” used herein represents the distance between the two valleys located at two sides of the columnar structure.

The prismatic columnar structure used in the present invention is known to a person of ordinary skill in the art and has two slant surfaces, either curved or flat. The two slant surfaces meet at the top of the prism to form a peak. Each of the surfaces meets one slant surface of an adjacent columnar structure at the bottom to form a valley.

The arc columnar structure used in the present invention is known to a person of ordinary skill in the art and has two slant surfaces. The top where the two slant surfaces meet is blunt-shaped. Each of the two slant surfaces meets other one slant surface of an adjacent columnar structure at the bottom to form a valley.

The term “top of the blunt-shaped surface of an arc columnar structure” is defined as the peak of the arc columnar structure and the height of the arc columnar structure means the perpendicular distance from the peak to the bottom of the arc columnar structure.

The intersected angle of the extension of the two slant surfaces of an arc columnar structure is defined as the apex angle of said arc columnar structure.

The term “linear columnar structure” used herein represents a columnar structure with a linear ridge extending along the length direction.

The term “serpentine columnar structure” used herein represents a columnar structure with a serpentine ridge extending along the length direction. The curvature of the serpentine ridge varies properly and the variation is in a range of 0.2% to 100%, preferably 1% to 20%, of the nominal height (i.e., the average height) of the serpentine columnar structure.

The substrate for the optical film of the present invention can be made of any materials known in the art, for example, glass or plastic materials. A plastic substrate can be composed of one or more layers of polymeric resins. The plastic substrate is not particularly limited. Suitable materials include but are not limited to polyester resins such as polyethylene terephthalate (PET) and polyethylene naphthalate (PEN); polyacrylate resins such as polymethyl methacrylate (PMMA); polyolefin resins such as polyethylene (PE) and polypropylene (PP); polystyrene resins; polycycloolefin resins; polyimide resins; polycarbonate resins; polyurethane resins; triacetate cellulose (TAC); polylactic acid; or a mixture thereof, of which PET, PMMA, polycycloolefin resins, TAC, polylactic acid or a mixture thereof are preferred, and PET is more preferred. The thickness of the substrate usually depends on the requirements of the optical product, and is preferably between about 50 μm to about 300 μm.

The microstructured layer of the optical film according to the present invention provides desirable optical properties. The microstructured layer and the substrate can be formed as a unibody and the microstructures can be directly prepared by embossing or processing on the substrate by any conventional means, such as directly coating a microstructured layer on the substrate or coating a resin layer on the substrate and then embossing the layer to form the micro structures. The thickness of the microstructured layer is not particularly limited and is usually in the range from about 1 μm to 50 μm, preferably from 5 μm to 30 μm and more preferably from 15 μm to 25 μm.

The structured surface layer of the optical film of the present invention may be composed of any resin that has a refractive index higher than that of air. In general, the higher the refractive index is, the better the effect will be. The optical film of the present invention has a refractive index of at least 1.50, preferably 1.50 to 1.7. The resins suitable for forming the microstructured layer of the present invention are known to a person of ordinary skill in the art and, which can be for example, but are not limited to, acrylate resins, polyamide resins, epoxy resins, fluoro resins, polyimide resins, polyurethane resins, alkyd resins, polyester resins and a mixture thereof, of which acrylate resins are preferred. The monomers which can be used for the preparation of the acrylate resins include, but are not limited to, acrylate monomers, which include, but are not limited to an acrylate, a methacrylate, urethane acrylate, polyester acrylate, epoxy acrylate and a mixture thereof, preferably an acrylate or a methacrylate. In addition, the above acrylate monomers may include one or more functional groups, preferably including multiple functional groups.

Examples of the acrylate monomers that can be used in the present invention are selected from the group consisting of (meth)acrylate, tripropylene glycol di(meth)acrylate, 1,4-butanediol di(meth)acrylate, 1,6-hexanediol di(meth)acrylate, polyethyleneglycol di(meth)acrylate, allylated cyclohexyl di(meth)acrylate, isocyanurate di(meth)acrylate, 2-phenoxyl ethyl (meth)acrylate, ethoxylated trimethylol propane tri(meth)acrylate, propoxylated glycerol tri(meth)acrylate, trimethylol propane tri(meth)acrylate, cumyl phenoxyl ethyl acrylate (CPEA) and a mixture thereof.

Examples of the commercially available acrylate monomers that can be used include those with the trade names SR454®, SR494®, SR9020®, SR9021®, and SR9041®, produced by Sartomer Company; those with the trade names 624-100® and EM210® or EM2108® produced by Eternal Company; and those with the trade names Ebecryl 600®, Ebecryl 830®, Ebecryl 3605®, and Ebecryl 6700®, produced by UCB Company.

Conventional additives, for example, photo initiator, crosslinking agent, inorganic particulates, leveling agent, antifoaming agent, or antistatic agent can be optionally added to the resin for forming the microstructured layer. Suitable species of such additives are well known to persons skilled in the art.

Antistatic agents can be added to the resin for forming the microstructured layer to enhance the antistatic ability of the optical film so as to increase the production yield. Suitable antistatic agents for the present invention are well known to persons having ordinary skill in the art and include for example but are not limited to ethoxy glycerin fatty acid esters, quaternary amine compounds, aliphatic amine derivatives, epoxy resin (e.g., polyethylene oxide), siloxane and other alcohol derivatives (e.g., polyethylene glycol ester or polyethylene glycol ether.

Photo initiators for the present invention are those producing free radicals when exposed to light and inducing polymerization via the delivering of the free radicals. Suitable photo initiators are known to a person of ordinary skill in the art and include, for example but are not limited to, benzophenone, benzoin, 2-hydroxy-2-methyl-1-phenyl-propan-1-one, 2,2-dimethoxy-1,2-diphenylethan-1-one, 1-hydroxy cyclohexyl phenyl ketone, 2,4,6-trimethylbenzoyl diphenyl phosphine oxide or a mixture thereof. Preferred photo initiators are benzophenone and 1-hydroxy cyclohexyl phenyl ketone.

To increase the hardness of the microstructured layer, nano-scale inorganic particulates can be optionally added to the resin. Suitable inorganic particulates are known to a person of ordinary skill in the art and include, for example but are not limited to, zinc oxide, silicon dioxide, strontium titanate, zirconium oxide, aluminum oxide, titanium dioxide, calcium sulphate, barium sulphate or a mixture thereof, of which titanium dioxide, zirconium oxide, silicon dioxide, zinc oxide or a mixture thereof is preferred. The above-mentioned inorganic particulates have a particle size of about 50 nm to about 350 nm.

The microstructured layer according to the present invention comprises a plurality of columnar structures. The columnar structures can be linear, serpentine or zigzag and their peak heights can vary along the length direction or not. The expression “the height of the columnar structure varies along the length direction” means that at least part of the columnar structure randomly or regularly varies in heights along the length direction, and the range of the variation is at least 3%, preferably 5% to 50% of the nominal height (i.e., average height).

The columnar structures of the microstructured layer include at least one single-peaked columnar structure. The columnar structures of the microstructured layer can be arc columnar structures, prismatic columnar structures or a mixture thereof, of which prismatic columnar structures are preferred. Preferably, the columnar structures are symmetric so as to simplify the processing and control the light-gathering effect of the microstructured layer more easily.

The columnar structures according to the present invention can be of the same or different heights and of the same or different widths. Preferably, the columnar structures are composed of at least two members selected from the group consisting of a linear columnar structure with its height varying along the length direction, a linear columnar structure without its height varying along the length direction, a serpentine columnar structure with its height varying along the length direction and a serpentine columnar structure without its height varying along the length direction, and have the same widths and apex angles. The heights of the columnar structures of the present invention depend on the requirements of the optical product to be made. Generally, the heights are in a range from 5 μm to 100 μm, preferably 10 μm to 50 μm, and more preferably 20 μm to 40 μm.

The columnar structures according to the present invention can be prismatic or arc-shaped. When arc structures are employed, the radius of curvature at the top of the arc structure is in a range from 2 μm to 50 μm, preferably from 3 μm to 35 μm, and more preferably from 5 μm to 20 μm. The apex angles of the prismatic or arc-shaped columnar structures can be the same or different and range from 40° to 120°, preferably 60° to 95°. To provide both high abrasion resistance and high brightness, the apex angle of a prismatic columnar structure is preferably in a range from 80° to 95° and the apex angle of an arc columnar structure is preferably in a range from 60° to 95°.

When the microstructured layer of the present invention is composed of two types of columnar structures (represented by x₁ and x₂) or more types of columnar structures (represented by x₁, x₂, x₃ . . . ), the columnar structures can be arranged in any suitable sequence, i.e., they can be randomly arranged in the sequence of, for example but not limited to, x₁x₁x₂x₁x₂x₁ or x₁x₂x₁x₁x₂, or in a repetitious sequence, for example but not limited to x₁x₂x₁x₂x₁x₂ or x₁x₁x₂x₁x₁x₂. Preferably, the microstructured layer of the present invention is composed of two types of columnar structures arranged in a repetitious sequence.

According to a preferred embodiment of the present invention, the optical film can be produced by continuous roll-to-roll techniques, that is, coating a diffusion layer which is capable of diffusing light rays and then coating a microstructured layer as a brightness enhancing layer on the diffusion layer. The diffusion layer comprises transparent particles and the refractive index of the transparent particles is 0.05 to 1.1 greater than that of the brightness enhancing layer. The transparent particles used in the present invention are not particularly limited and can be glass beads, particles of metal oxides, plastic beads or a mixture thereof. The plastic beads are not particularly limited and are, for example but not limited to, acrylate resins, styrene resins, urethane resins, silicone resins or a mixture thereof. The particles of metal oxides are not particularly limited and are, for example but not limited to TiO₂, SiO₂, ZnO, BaSO₄, Al₂O₃, ZrO₂ or a mixture thereof. The shape of the transparent particles is not particularly limited and can be, for example, spherical, diamond-shaped, oval, or biconvex lenses-shaped. The average particle size of the transparent particles is in a range from 1 μm to 50 μm, preferably from 3 μm to 30 μm, and more preferably from 5 μm to 20 μm. The refractive index of the transparent particles is from 1.5 to 2.5, preferably 1.9.

To avoid scratches on the surface of a substrate and adversely affecting the optical properties of the film, an anti-scratch layer can be applied to the surface of the substrate opposing to the microstructure layer. The anti-scratch layer can be smooth or matte. The anti-scratch layer of the present invention can be made by any conventional technique which is, for example but not limited to, screen printing, spray coating, embossing processing or applying a diffusion particles-containing anti-scratch coating to the substrate surface. Among the above techniques, the method of applying a diffusion particles-containing anti-scratch coating provides the anti-scratch layer with certain light-diffusing effect. The thickness of the anti-scratch layer is preferably from 0.5 μm to 30 μm, more preferably from 1 μm to 10 μm. The above-mentioned diffusion particles can be in a shape of spheres, diamonds, ovals, or biconvex lenses. The particle size thereof is preferably in a range from 1 μm to 30 μm. The species of the diffusion particles are not particularly limited and can be organic or inorganic particles, preferably organic particles, such as those of polyacrylate resins, polystyrene resins, polyurethane resins, silicone resins or a mixture thereof, of which polyacrylate resins are preferred.

The properties of an optical product can be represented by haze (Hz), which is related to the light scattering property of the product, and total transmittance (Tt), which is related to the light transmittance of the optical product. Measurements of the anti-scratch layer of the present invention according to JIS K7136 standard (without a microstructured layer on the other side) show that the haze of the resin coating is of 1% to 90%, preferably 5% to 40%, which means that the anti-scratch layer is capable of diffusing light. In addition, measurements of the optical film according to JIS K7136 standard show that the total transmittance of the optical film of the present invention is not lower than 60%, preferably higher than 80%, and more preferably 90% or greater. In addition, measurements of the anti-scratch layer of the present invention according to JIS K5400 standard show that the anti-scratch layer has a pencil hardness of 3H or more.

Any suitable conventional methods can be used for manufacturing the microstructured layer and the anti-scratch layer for the optical film according to the present invention. The manufacturing order of the microstructured and anti-scratch layers is not particularly limited. For example, the microstructured layer of the optical film according to the present invention can be made by the process comprising the following steps:

(a) mixing resins with appropriate additives to form a colloidal coating composition;

(b) axially moving a diamond tool with radial and stepping movements on a rotating cylindrical roll (referred to as the “roller”) to carve specific linear columnar grooves on the roller by controlling the movement speed of the diamond tool and/or the rotation speed of the roller, and changing the c-axis rotation speed of the roller or the harmonic modes of the diamond tool to achieve vertically or horizontally continuous variations on the surface of the roller;

(c) applying the colloidal coating composition onto a substrate or roller, and then performing a roller embossing, thermo-transfer printing, or thermo-extruding on the carved roller obtained from step (b) so as to form a structured surface on the coating; and

(d) irradiating and/or heating the coating layer to cure the coating layer.

The above process is characterized in that at least two processings are employed. The so-called at least two processings means at least two different patterns of grooves are formed on the roller. The above process is advantageous because it is simple and the production yield can be maximized.

The present invention will be illustrated below in detail by the embodiments with reference to the drawings, which are not intended to limit the scope of the present invention. It will be apparent that any modifications or alterations that are obvious to persons skilled in the art fall within the scope of the disclosure of the specification.

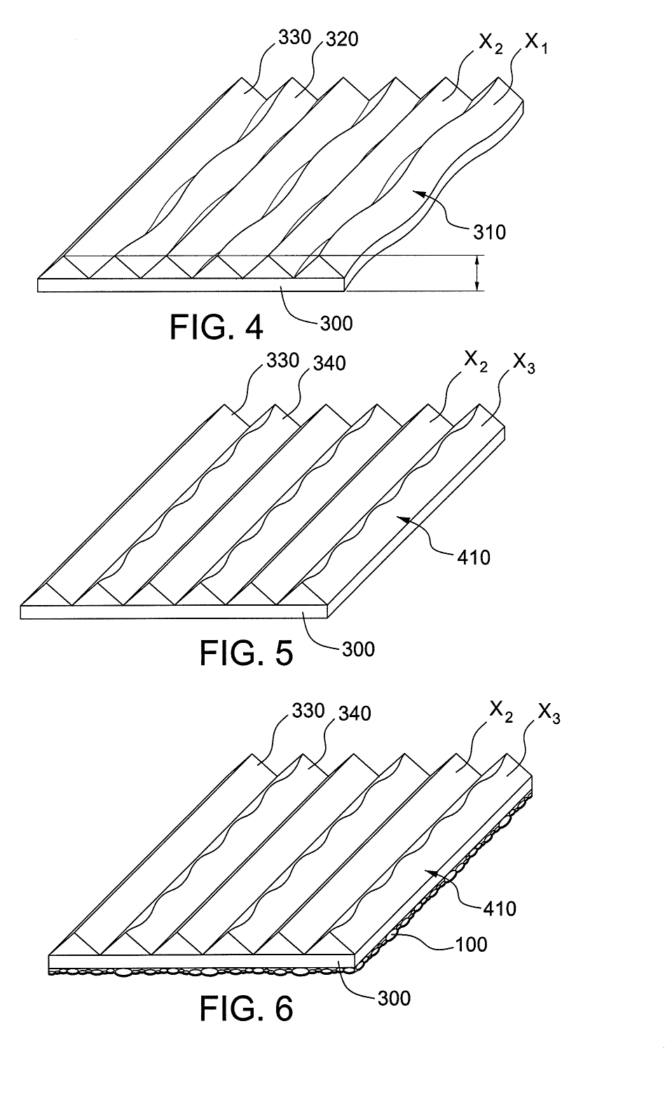

As shown in FIGS. 4 to 13, the optical film according to the present invention includes a microstructured layer (310, 410, 510, 610 and 710) on the surface of a substrate (300). The microstructured layer can be prepared together with the substrate to form a unibody or manufactured by any suitable conventional processing method such as coating and embossing on a substrate to form a microstructured layer, or applying a coating and then embossing the desired structure.

In one embodiment according to the present invention, the microstructured layer comprises a plurality of columnar structures, wherein the columnar structures comprise a plurality of linear columnar structures and a plurality of serpentine columnar structures. In a preferred embodiment, the columnar structures comprise single-peaked serpentine columnar structures (320) (x₁) with their heights varying along the length direction and single-peaked linear columnar structures (330) (x₂) without their heights varying along the length direction. The columnar structures are alternatively configured as x₁x₂x₁x₂x₁x₂, as shown in FIG. 4. The microstructured layer of the embodiment shown in FIG. 4 employs single-peaked prismatic columnar structures having the same heights, widths, and apex angles.

In another embodiment according to the present invention, the microstructured layer is composed of a plurality of columnar structures which are linear columnar structures and the heights of part of the columnar structures vary along the length direction, as shown in FIGS. 5 to 8. The columnar structures of the microstructure layer are single-peaked prismatic columnar structures having the same heights, widths, and apex angles.

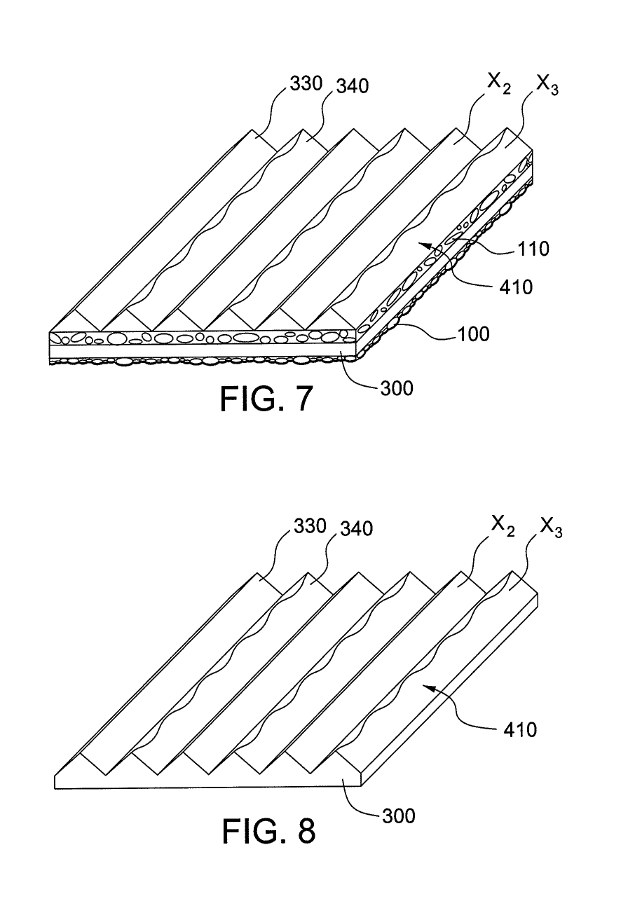

In FIGS. 5 to 8, the columnar structures are composed of single-peaked linear columnar structures (340) (x₃) with their heights varying along the length direction and single-peaked linear columnar structures (330) (x₂) without their heights varying along the length direction, and the columnar structures are alternatively configured as x₃x₂x₃x₂x₃x₂. In the embodiment of FIG. 5, the surface of the substrate opposing to the microstructured layer is smooth. In the embodiment of FIG. 6, an anti-scratch layer (100) comprising diffusion particles is positioned on the surface of the substrate opposing to the microstructured layer. In the embodiment of FIG. 7, a diffusion layer (110) is coated on the substrate and a microstructured layer is further coated on the diffusion layer (110) as a brightness enhancing layer. The diffusion layer contains transparent particles. On the surface of the substrate opposing to the microstructured layer is an anti-scratch layer (100) containing diffusion particles. In the embodiment of FIG. 8, the microstructured layer and the substrate is formed together as a unibody.

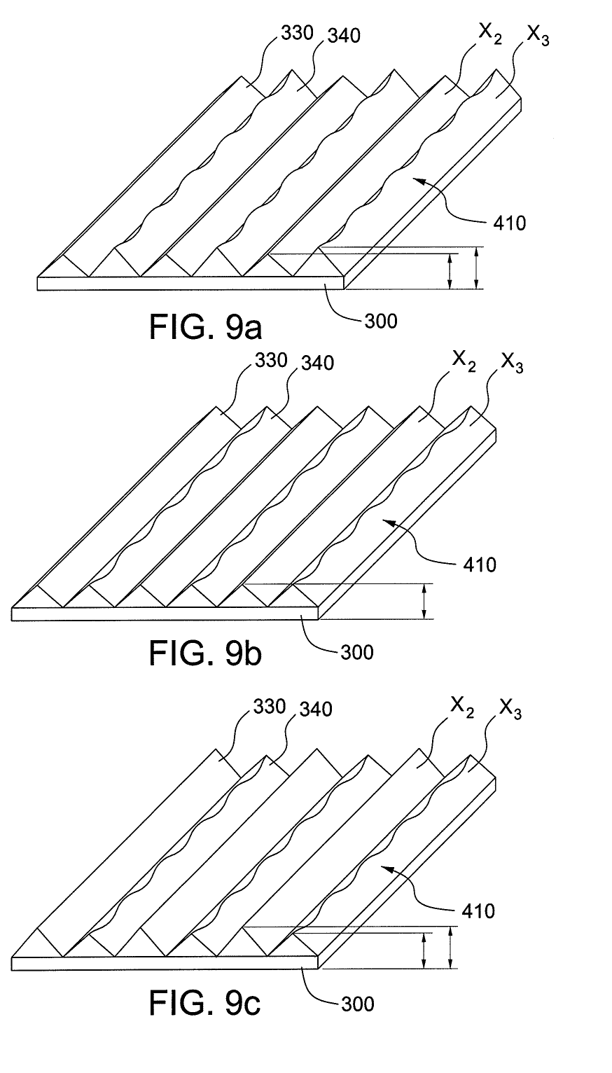

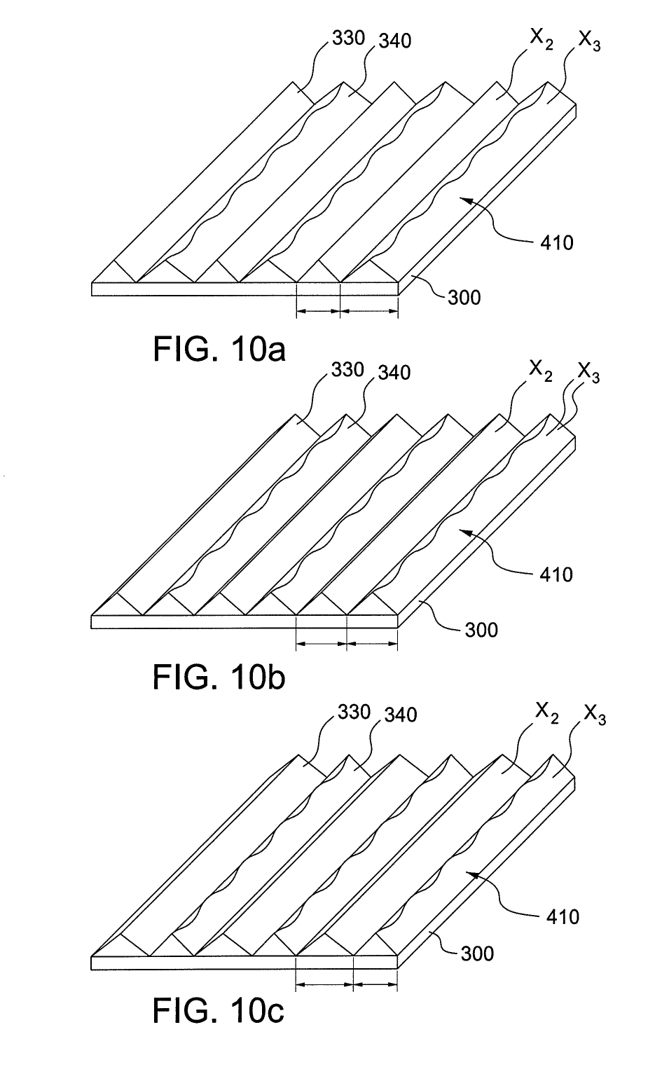

FIGS. 9 and 10 show that the columnar structures of the microstructured layer according to the present invention can be of the same heights (as shown in FIGS. 9b and 10b), of different heights (as shown in FIGS. 9a and 9c), of the same widths (as shown in FIGS. 9b and 10b) or of different widths (as shown in FIGS. 10a or 10c).

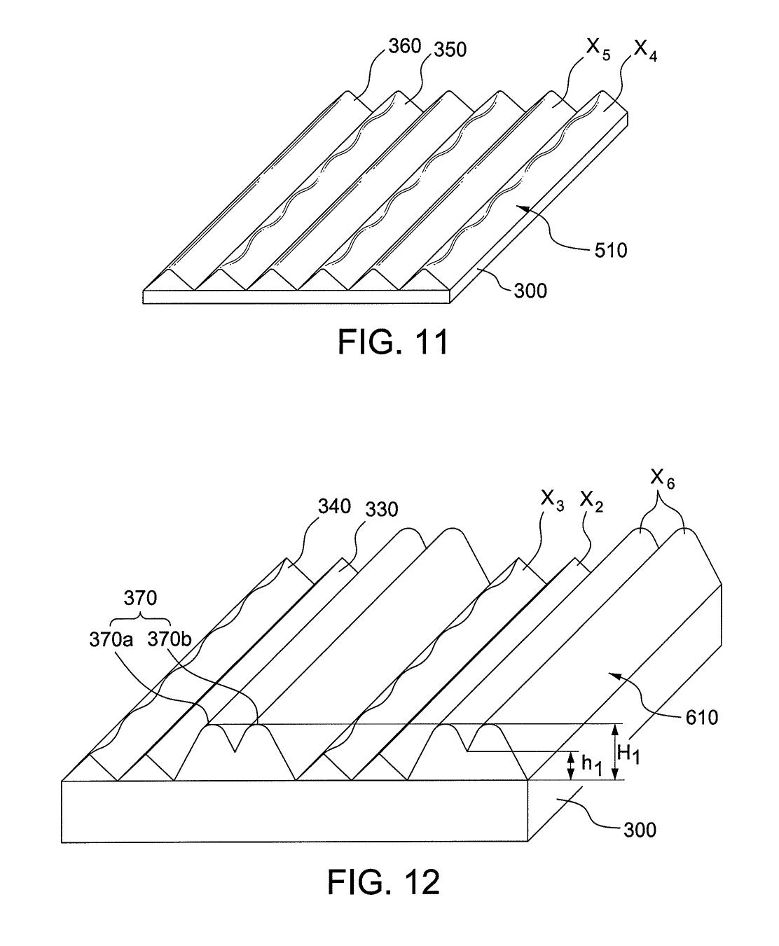

In yet another embodiment of the present invention, the microstructured layer is composed of a plurality of linear arc columnar structures and the heights of part of the linear arc column structures vary along the length direction, as shown in FIG. 11. The columnar structures of the microstructured layer are single-peaked arc columnar structures with the same heights, widths and apex angles. In the embodiment of FIG. 11, the columnar structures comprise single-peaked linear columnar structures (350) (x₄) with theirs heights varying along the length direction and single-peaked linear columnar structure (360) (x₅) without their heights varying along the length direction. The columnar structures are alternatively configured as x₄x₅x₄x₅x₄x₅.

In yet another embodiment of the present invention, the microstructured layer is composed of a plurality of columnar structures. In the embodiment shown in FIG. 12, the columnar structures comprise single-peaked linear columnar structure (340) (x₃) with their heights varying along the length direction, singled-peaked linear columnar structures (330) (x₂) without their heights varying along the length direction, and multi-peaked linear columnar structures (370) (x₆) without their heights varying along the length direction. The columnar structures are repetitiously arranged as x₆x₂x₃x₆x₂x₃x₆x₂x₃. The multi-peaked columnar structure (370) is a combined structure of two arc columnar structures of the same heights (370a [symbol] 370b) that overlap each other. The height h₁ of the valley between the arc columnar structures (370a and 370b) is 60% of the height H₁ of the arc columnar structures (370a [symbol] 370b). The single-peaked prismatic columnar structures (330) are of the same heights, widths, and apex angles and the heights do not vary along the length direction. Single-peaked prismatic columnar structures (340) are of the same heights and widths, and the heights vary along the length direction.

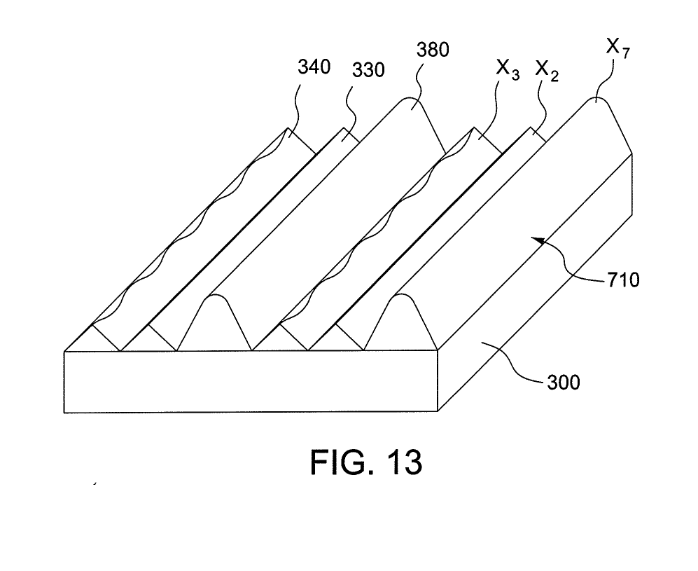

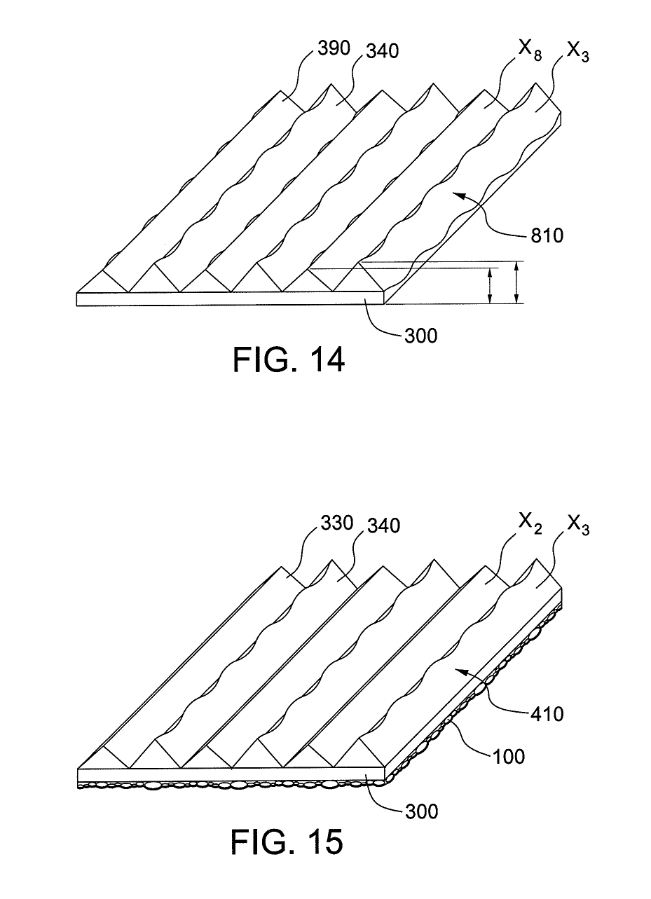

In a further embodiment of the present invention, the microstructured layer is composed of a plurality of columnar structures, as shown in FIG. 13. In the embodiment of FIG. 13, the columnar structures comprises single-peaked linear prismatic columnar structures (340) (x₃) with heights varying along the length direction, single-peaked linear prismatic columnar structures (330) (x₂) without their heights varying along the length direction, and single-peaked linear arc columnar structures (380) (x₇) without their heights varying along the length direction. The columnar structures are repetitiously configured as x₇x₂x₃x₇x₂x₃x₇x₂x₃.

In another embodiment of the present invention, the microstructured layer is composed of a plurality of the columnar structures comprising single-peaked linear prismatic columnar structures (340) (x₃) with their heights varying along the length direction and single-peaked linear prismatic columnar structures (390) (x₈) without their heights varying along the length direction. The columnar structures are alternatively arranged as x₈x₃x₈x₃x₈x₃, as shown in FIG. 14. The columnar structures of the microstructured layer have the same heights, widths and apex angles. The single-peaked linear prismatic columnar structure (390) (x₈) has two slant surfaces, one being flat and the other being serpentine with a curvature variation of 0.2% to 100%, preferably 1% to 20%, based on the height of the serpentine columnar structure.

In another embodiment of the present invention, the columnar structures of the microstructured layer comprise single-peaked linear prismatic columnar structures (340) (x₃) with their heights varying along the length direction and single-peaked linear prismatic columnar structures (330) (x₂) without their heights varying along the length direction. The columnar structures are alternatively arranged as x₃x₂x₃x₂x₃x₂, as shown in FIG. 15. The columnar structures of the microstructured layer have the same apex angles, which are about 90°, but different heights (x₂>x₃) ranging from about 16 μm to 26 μm, with a difference in a range of 1 μm to 7 μm. An anti-scratch layer (100) comprising diffusion particles is positioned on the surface of the substrate opposing to the microstructured layer. The thickness of the anti-scratch layer is in a range from about 1 μm to about 5 μm. The diffusion particles are polyacrylate resin particles with a particle size in a range from about 2 μm to about 7 μm. Measurement of the anti-scratch layer according to JIS K7136 standard shows a haze of 10%-30%. The heights of the above-mentioned columnar structures vary regularly and along the length direction as a wave function. The wavelength is in a range from about 0.5 μm to 2 μm, and the variation in intensity is 5% to 30% of the average height of the columnar structure.

What is claimed is:

1. An optical film comprising a substrate and a microstructured layer on a surface of the substrate, wherein the microstructured layer comprises a plurality of columnar structures and the columnar structures comprise at least two members selected from the group consisting of a linear columnar structure with its height varying along the length direction, a linear columnar structure without its height varying along the length direction, a serpentine columnar structure with its height varying along the length direction and a serpentine columnar structure without its height varying along the length direction.

2. The optical film of claim 1, wherein the columnar structures are selected from the group consisting of an arc columnar structure, prismatic columnar structure and a mixture thereof.

3. The optical film of claim 1, wherein the linear columnar structures with their heights varying along the length direction or the serpentine columnar structures with their heights varying along the length direction have a nominal height, the heights of at least part of the columnar structures vary randomly, and the variation is at least 3% of the nominal height.

4. The optical film of claim 3, wherein the variation is in a range from 5% to 50% of the nominal height.

5. The optical film of claim 2, wherein the apex angles of the prismatic columnar structures and/or arc columnar structures are in a range from 40° to 120°.

6. The optical film of claim 5, wherein the apex angles of the prismatic columnar structure and/or arc columnar structures are in a range from 60° to 95°.

7. The optical film of claim 2, wherein the arc columnar structures have a radius of curvature at the top of the structures in a range from 2 μm to 50 μm.

8. The optical film of claim 1, wherein the heights of the columnar structures are in a range from 5 μm to 100 μm.

9. The optical film of claim 1, wherein the serpentine columnar structure have a serpentine ridge extending along the length direction wherein the curvature of the serpentine ridge varies in a range from 0.2% to 100% of the height of the columnar structure.

10. The optical film of claim 9, wherein the curvature of the serpentine ridge varies in a range from 1% to 20% of the height of the columnar structure.

11. The optical film of claim 1, wherein the columnar structures are symmetric columnar structures.

12. The optical film of claim 1, wherein an anti-scratch layer is positioned on the surface of the substrate opposing to the microstructured layer.

13. An optical film comprising a substrate a microstructured layer on a surface of the substrate, wherein the microstructured layer comprises a plurality of columnar structures and the columnar structures comprise linear columnar structures and serpentine columnar structures that are repetitiously configured.

14. The optical film of claim 13, wherein the columnar structures are selected from the group consisting of arc columnar structures, prismatic columnar structures and a mixture thereof.

15. The optical film of claim 13, wherein the columnar structures have a height in a range from 5 μm to 100 μm.

16. The optical film of claim 13, wherein the heights of the linear columnar structure do not vary along the length direction.

17. The optical film of claim 13, wherein the heights of the linear columnar structures vary along the length direction.

18. The optical film of claim 17, wherein the linear columnar structures with their heights varying along the length direction have a nominal height, the heights of at least part of the columnar structures vary randomly, and the variation is at least 5% of the nominal height.

19. The optical film of claim 13, wherein the heights of the serpentine columnar structures do not vary along the length direction.

20. The optical film of claim 14, wherein the apex angles of the prismatic columnar structures and/or arc columnar structures are in a range from 60° to 95°.

21. The optical film of claim 13, wherein the heights of the columnar structures do not vary along the length direction and the repetitious configuration is done by alternating the linear columnar structures and serpentine columnar structures.

22. The optical film of claim 13, wherein the repetitious configuration is done by alternating the linear columnar structures and serpentine columnar structures and the heights of the linear columnar structures vary along the length direction.

23. An optical film comprising a substrate and a microstructured layer on a surface of the substrate, wherein the microstructured layer comprises a plurality of columnar structures and the columnar structures comprise linear columnar structures with their heights varying along the length direction and linear columnar structures without their heights varying along the length direction that are repetitiously configured.

24. The optical film of claim 23, wherein the linear columnar structures with their heights varying along the length direction have a nominal height, the heights of at least part of the columnar structures vary randomly, and the variation is in a range from 5% to 50% of the nominal height.

25. The optical film of claim 23, wherein the columnar structures are selected from the group consisting of arc columnar structures, prismatic columnar structures and a mixture thereof.

26. The optical film of claim 23, wherein the columnar structures are prismatic columnar structures.

27. The optical film of claim 26, wherein the prismatic columnar structures have a height in a range from 5 μm to 100 μm.

28. The optical film of claim 26, wherein the apex angles of the prismatic columnar structures and/or the arc columnar structure are in a range from 80° to 95°.

29. The optical film of claim 23, wherein the columnar structures have the same heights, widths, and apex angles.

30. The optical film of claim 23, wherein the heights of the linear columnar structures with their heights varying along the length direction are greater than the heights of the linear columnar structures without their heights varying along the length direction.

31. The optical film of claim 23, wherein the repetitious arrangement is done by alternating the linear columnar structures with their heights varying along the length direction and the linear columnar structures without their heights varying along the length direction.

32. The optical film of claim 23 wherein the microstructured layer is manufactured by a processing method including embossing at least two patterns of grooves.

33. The optical film of claim 23, wherein the columnar structures comprise single-peaked linear columnar structures with their heights varying along the length direction and single-peaked linear column structures without their heights varying along the length direction in repetitious configuration.

34. The optical film of claim 23, wherein the columnar structures comprise single-peaked linear columnar structures with their heights varying along the length direction, single-peaked linear columnar structures without their heights varying along the length direction, and multi-peaked linear columnar structures without their heights varying along the length direction in repetitious configuration.

35. The optical film of claim 34, wherein the columnar structures comprise single-peaked linear prismatic columnar structures with their heights varying along the length direction, single-peaked linear prismatic columnar structures without their heights varying along the length direction, and multi-peaked linear arc columnar structures without their heights varying along the length direction in repetitious configuration.

36. The optical film of claim 23, wherein the columnar structures comprise single-peaked linear prismatic columnar structures with their heights varying along the length direction, single-peaked linear prismatic columnar structures without their heights varying along the length direction, and single-peaked linear arc columnar structures without their heights varying along the length direction in repetitious configuration.

37. The optical film of claim 23, wherein the linear columnar structures without their heights varying along the length direction are prismatic columnar structures and each of them has two slant surfaces, one being flat and the other being serpentine with a curvature variation of 1% to 20% of the height of the serpentine columnar structures.
